(19) United States
(12) Patent Application Publication
(10) Pub. No.: US 2025/0009162 A1
(43) Pub. Date: Jan. 9, 2025

(54) ULTRASONIC EXTRACTION MACHINE CAPABLE OF IMPROVING INFUSION EFFICIENCY AND CONCENTRATION

(71) Applicant: Ningbo Demao Decoration Co., Ltd., Ningbo (CN)

(72) Inventor: XIAOZHOU SHEN, Shanghai (CN)

(73) Assignee: Ningbo Demao Decoration Co., Ltd., Ningbo (CN)

(21) Appl. No.: 18/347,007

(22) Filed: Jul. 5, 2023

(30) Foreign Application Priority Data
Jul. 5, 2023 (CN) 2023108199489

(51) Int. Cl. A47J 31/10; A47J 31/44; A47J 31/52

(52) U.S. Cl. CPC A47J 31/10; A47J 31/4439; A47J 31/5253

(57) ABSTRACT

This invention relates to the field of extraction machine technology, and specifically discloses an ultrasonic extraction machine that can improve infusion efficiency and increase concentration. The machine includes an extraction kettle, a base, and a control panel. The base includes a platform for placing the extraction kettle, and the top and the bottom of the extraction kettle are respectively equipped with a heating component and an ultrasonic component. Both the heating component and the ultrasonic component are connected to the control panel. The invention introduces an ultrasonic device during the heating process, and infuse through a dual structure of heating and ultrasonics, which can greatly improve the speed and increase the concentration of the extraction.

### TECHNICAL FIELD

This invention relates to the field of extraction machine technology, specifically to an ultrasonic extraction machine with improved infusion efficiency and increased concentration.

### BACKGROUND

Existing plant extraction machines use heating elements to heat the extraction kettle during the infusion process. The heating elements heat the heating tube and heating plate, which in turn heat the extraction kettle. This increases the acceleration and concentration of the extracted solution. However, this heating infusion method has been in use for a long time without too much innovation, and its ability to increase the speed and concentration of the extracted solution is limited, which cannot meet market demand.

### SUMMARY

In view of the draw backs of the existing technology, the present invention provides an ultrasonic extraction machine with improved infusion efficiency and increased concentration. The machine introduces an ultrasonic device during the heating process and carries out infusion through a dual structure of heating and ultrasonics, greatly improving the speed and increasing concentration of the extraction.

The ultrasonic extraction machine with improved infusion efficiency and increased concentration includes an extraction kettle, a base, and a control panel. The base includes a platform for placing the extraction kettle. The top and the bottom of the extraction kettle are equipped with heating components and ultrasonic components, which are connected to the control panel.

In the above description, as a preferred option, there is an inwardly recessed extraction area on one side of the base, and the platform is set at the bottom of the extraction area. The bottom of the extraction area is equipped with an installation cavity, and the heating component is placed in the installation cavity.

In the above description, as a preferred option, the side wall of the extraction area is equipped with a sensor trigger device, which is connected to the control panel.

In the above description, as a preferred option, the heating component includes a heating plate, a heating tube, and a temperature controller. The heating tube is connected to the heating plate, and the heating plate is set on the platform. The temperature controller is connected to both the heating tube and the control panel. The temperature controller and heating tube are set inside the cavity.

In the above description, as a preferred option, the extraction kettle includes a kettle body, an upper kettle cover, and a lower kettle cover. The ultrasonic component is set at the lower end of the kettle cover and can extend downward into the kettle body.

In the above description, as a preferred option, there is a triangularly arranged positioning protrusion on the heating plate, and the bottom of the kettle body is provided with a positioning groove that adapts to the positioning protrusion.

In the above description, as a preferred option, the ultrasonic component includes an ultrasonic probe, a magnetic coupler, a magnetic plug, and a drive circuit board. The ultrasonic probe is set at the lower end of the lower kettle cover, and the magnetic coupler is connected to both the magnetic plug and the ultrasonic probe. The drive circuit board is connected to both the magnetic plug and the control panel, and a driver is set on the drive circuit board.

In the above description, as a preferred option, one side of the upper kettle cover has a square installation position surrounded by the two sides of the cover. The magnetic coupler is installed in the square installation position, and the outer side of the magnetic plug is provided with a square shell corresponding to the size of the square installation position.

In the above description, as a preferred option, there is an outwardly extending power plug on the base, which is connected to the drive circuit board.

In the above description, as a preferred option, the bottom of the base is equipped with a heat dissipation fan and heat dissipation holes for heat dissipation.

The beneficial effects of this invention are: by setting heating components and ultrasonic components at both ends of the extraction kettle and controlling them through the control panel, infusion is carried out through a dual structure of heating and ultrasonics, greatly improving the speed and increasing concentration of the extraction.

### BRIEF DESCRIPTION OF DRAWINGS

FIG. 1: Structural schematic diagram of an embodiment of the invention;

FIG. 2: Overhead directional structural schematic diagram of the embodiment of the invention:

FIG. 3: Cross-sectional structural schematic diagram of the embodiment of the invention:

FIG. 4: Internal structural schematic diagram of the embodiment of the invention:

FIG. 5: Schematic diagram of the disassembled structure of the extraction kettle of the embodiment of the invention;

FIG. 6: Structural schematic diagram of the positioning protrusion of the embodiment of the invention:

FIG. 7: Structural schematic diagram of the positioning groove of the embodiment of the invention;

Attached figure identification instructions: 10—base, 101—power plug, 102—heat dissipation fan, 103—heat dissipation hole, 11—platform, 12—extraction area, 121—installation cavity, 122—sensor trigger device, 13—heating plate, 131—positioning protrusion, 14—heating tube, 15—temperature controller, 16—ultrasonic probe, 17—magnetic coupler, 18—magnetic plug, 181—square shell, 19—drive circuit board, 20—extraction kettle, 21—kettle body, 22—upper kettle cover, 23—lower kettle cover, 24—positioning groove, 25—square installation position, 30—control panel.

### DETAILED DESCRIPTION OF THE EMBODIMENTS

In order to more clearly illustrate the structural features, technical means, and specific objectives and functions of this invention, the following is a further detailed description of the present invention in conjunction with the attached drawings and specific embodiments:

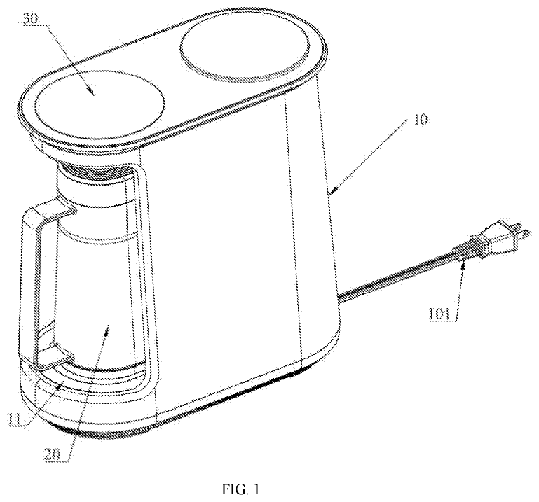

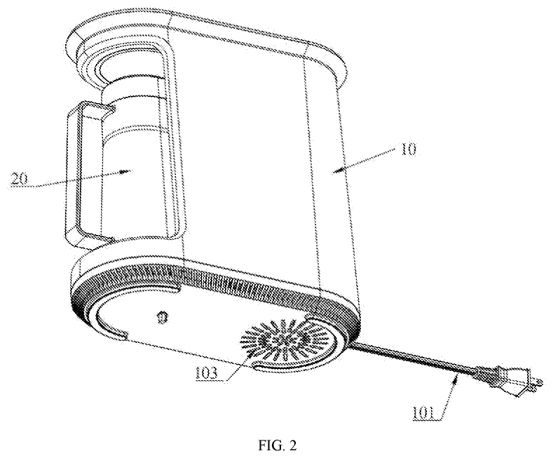

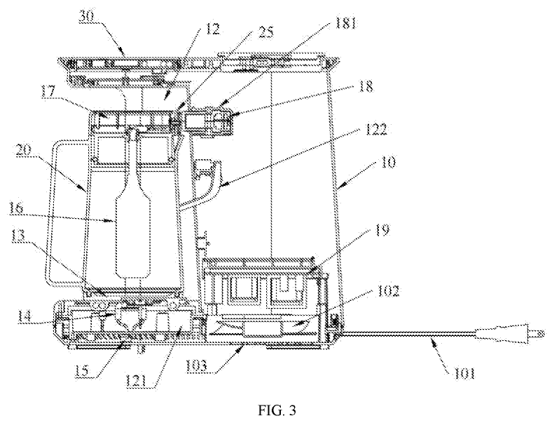

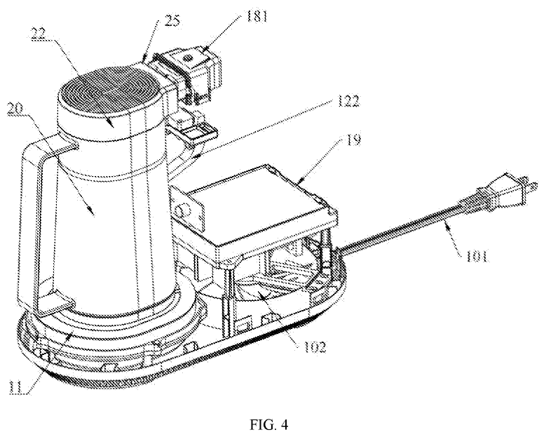

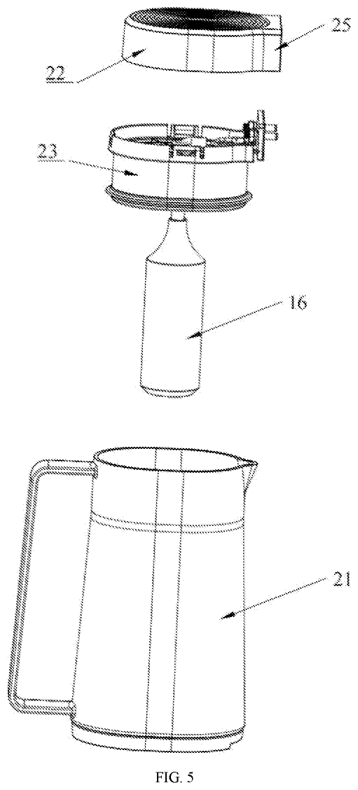

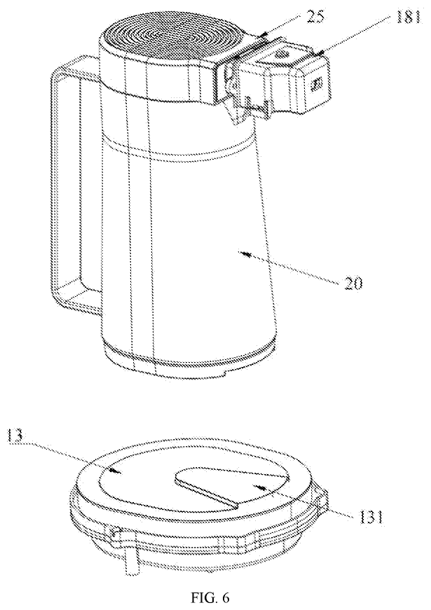

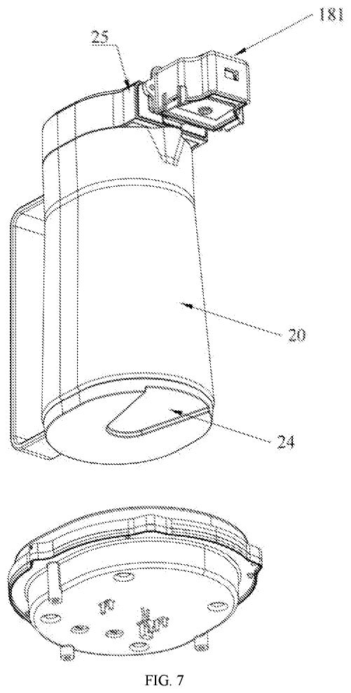

This embodiment: As shown in FIGS. 1-7, the ultrasonic extraction machine with improved infusion efficiency and concentration includes an extraction kettle 20, a base 10, and a control panel 30. The base 10 includes a platform 11 for placing the extraction kettle 20. The top and the bottom of the extraction kettle 20 are equipped with heating components and ultrasonic components, both of which are connected to the control panel 30. The base 10 has an inwardly recessed extraction area 12 on one side, with the placement position 11 set in the extraction area 12. The side wall of the extraction area 12 is equipped with a sensor trigger device 122, which is connected to the control panel 30. The sensor trigger device 122 is a touch switch. When the extraction kettle 20 is placed onto the platform, the side wall of the extraction kettle 20 contacts the touch switch, and the control panel 30 controls the operation of the ultrasonic components to avoid ultrasonic idle vibration. The bottom of the extraction area 12 is provided with an installation cavity 121, and the heating component is arranged in the installation cavity 121. The heating component includes a heating plate 13, a heating tube 14, and a temperature controller 15. The heating tube 14 is connected to the heating plate 13, and the heating plate 13 is set on the platform 11. The temperature controller 15 is connected to both the heating tube 14 and the control panel 30. The temperature controller 15 and heating tube 14 are set inside the cavity. The control panel 30 controls the opening and closing of the heating tube 14 and the heating temperature through the temperature controller 15, maintaining the optimal infusion temperature required for the extraction kettle 20. The extraction kettle 20 includes a kettle body 21, an upper kettle cover 22, and a lower kettle cover 23. The heating plate 13 has a triangularly arranged positioning protrusion 131, and the bottom of the kettle body 21 is provided with a positioning groove 24 that adapts to the positioning protrusion 131. This avoids slight displacement of the extraction kettle 20 due to the vibration generated when the ultrasonic component is working, and also serves as a positioning function, making it easier for users to accurately place the extraction kettle 20 when needed. The ultrasonic component is set at the lower end of the lower kettle cover 23 and can extend downward into the kettle body 21 from the lower kettle cover 23. The ultrasonic component includes an ultrasonic probe 16, a magnetic coupler 17, a magnetic plug 18, and a drive circuit board 19. The ultrasonic probe 16 is set at the lower end of the lower kettle cover 23, and the magnetic coupler 17 is connected to both the magnetic plug 18 and the ultrasonic probe 16. The drive circuit board 19 is connected to both the magnetic plug 18 and the control panel 30. A driver is set on the drive circuit board 19. The control panel 30 controls the opening and closing of the ultrasonic probe 16 and the output power of the ultrasonic probe 16 through the drive circuit board 19, keeping it in the optimal infusion power state required for the extraction kettle 20. One side of the upper kettle cover 22 has a square installation position 25 surrounded by two side walls. The magnetic coupler 17 is installed in the square installation position 25, and the outer side of the magnetic plug 18 is provided with a square shell 181 corresponding to the size of the square installation position 25, making it easier for the magnetic coupler 17 and magnetic plug 18 to align positions, making the connection between the magnetic coupler 17 and magnetic plug 18 more convenient.

The base 10 is equipped with an outwardly extending power plug 101, which is connected to the drive circuit board 19. The power plug 101 is used to connect to an external power source. The bottom of the base 10 is provided with a heat dissipation fan 102 and heat dissipation holes 103 for heat dissipation. The heat dissipation fan 102 and heat dissipation holes 103 can dissipate heat from the interior of the base 10 in real-time, avoiding damage to the electronic components inside the machine seat 10 due to excessive temperature.

An immersion type ultrasonic probe 16 is installed on the lower cover 23 of the extraction kettle 20. After the lower cover 23 is closed on the kettle body 21, the ultrasonic probe 16 is immersed in the solution, and the infusion process is performed by releasing ultrasonic waves in the extraction solution through the control panel 30.

By setting heating components and ultrasonic components at both ends of the extraction kettle 20 and controlling them through the control panel 30, the infusion can be carried out using a double structure of heating and ultrasonic, which can greatly improve the speed and increase the concentration of the extraction.

It should be noted that in this embodiment, the temperature of the heating components is controlled by the control panel 30 to keep it within the range that the ultrasonic probe 16 can withstand, preventing damage to the ultrasonic probe 16 due to high temperature.

It should be noted that the type and model of the heating components and ultrasonic components in this embodiment can be replaced as needed.

It should be noted that the positions of the heating components and ultrasonic components in this embodiment can be adjusted as needed.

It should be noted that before the extraction work in this embodiment, the extraction kettle 20 can also perform decarboxylation by controlling the heating components to heat the extraction kettle to the temperature required for decarboxylation. After the decarboxylation is completed, the heating components stop working and wait for the temperature to drop to the temperature required for infusion. The heating components are then restarted to control the temperature of the extraction kettle, keeping it within the fixed temperature range required for infusion.

The above description is only a preferred embodiment of this invention and is not intended to limit the invention. Therefore, any modifications, equivalent substitutions, and improvements made to the above embodiments according to the technical scheme of the present invention are still within the scope of the technical scheme of the present invention.

What is claimed is:

1. An ultrasonic extraction machine capable of improving infusion efficiency and increasing concentration, including an extraction kettle, a base, and a control panel, characterized in that: the base includes a platform for placing the extraction kettle, and the top and the bottom of the extraction kettle are respectively equipped with a heating component and an ultrasonic component, both of which are connected to the control panel.

2. The ultrasonic extraction machine capable of improving infusion efficiency and increasing concentration according to claim 1, characterized in that: the side wall of the base is provided with an inwardly recessed extraction area, the platform is set below the extraction area, and the bottom of the extraction area is provided with an installation cavity, with the heating component set inside the installation cavity.

3. The ultrasonic extraction machine capable of improving infusion efficiency and increasing concentration according to claim 2, characterized in that: the side wall of the extraction area is provided with a sensing trigger device, which is connected to the control panel.

4. The ultrasonic extraction machine capable of improving infusion efficiency and increasing concentration according to claim 2, characterized in that: the heating component includes a heating plate, a heating tube, and a temperature controller, with the heating tube connected to the heating plate: The heating plate is set on the platform, and the temperature controller is connected to both the heating tube and the control panel: The temperature controller and heating tube are set inside the cavity.

5. The ultrasonic extraction machine capable of improving infusion efficiency and increasing concentration according to claim 1, characterized in that: the extraction kettle includes a kettle body, an upper kettle cover, and a lower kettle cover: The ultrasonic component is set at the lower end of the kettle cover and can extend downward into the kettle body from the kettle cover.

6. The ultrasonic extraction machine capable of improving infusion efficiency and increasing concentration according to claim 5, characterized in that: the heating plate is provided with a triangularly arranged positioning protrusion, and the bottom of the kettle body is provided with a positioning groove adapted to the positioning protrusion.

7. The ultrasonic extraction machine capable of improving infusion efficiency and increasing concentration according to claim 5, characterized in that: the ultrasonic component comprises an ultrasonic probe, a magnetic coupler, a magnetic plug, and a drive circuit board; The ultrasonic probe is set at the lower end of the kettle cover, the magnetic coupler is connected to both the magnetic plug and the ultrasonic probe, and the drive circuit board is connected to both the magnetic plug and the control panel; The drive circuit board is equipped with a driver.

8. The ultrasonic extraction machine capable of improving infusion efficiency and increasing concentration according to claim 7, characterized in that: one side of the upper kettle cover is provided with a square installation position enclosed by the two side of the upper cover, the magnetic coupler is installed on the square installation position, and the outer side of the magnetic plug is provided with a square shell corresponding to the size of the square installation position.

9. The ultrasonic extraction machine capable of improving infusion efficiency and increasing concentration according to claim 7, characterized in that: the base is provided with an outwardly extending power plug, which is connected to the drive circuit board.

10. The ultrasonic extraction machine capable of improving infusion efficiency and increasing concentration according to claim 1, characterized in that: the bottom of the base is provided with a heat dissipation fan and heat dissipation holes for heat dissipation.
